(19) United States
(12) Patent Application Publication
(10) Pub. No.: US 2025/0267541 A1
(43) Pub. Date: Aug. 21, 2025

(54) PROVIDING FEEDER-LINK SWITCHOVER EVENT INFORMATION

(71) Applicant: GOOGLE LLC, Mountain View, CA (US)

(72) Inventor: Ching-yu Liao, Mountain View, CA (US)

(21) Appl. No.: 19/055,399

(22) Filed: Feb. 17, 2025

Related U.S. Application Data
(60) Provisional application No. 63/554,827, filed on Feb. 16, 2024.
(60) Provisional application No. 63/554,893, filed on Feb. 16, 2024.

(51) Int. Cl. H04W 36/08; H04W 36/24; H04W 76/30; H04W 84/06

(52) U.S. Cl. CPC H04W 36/08; H04W 36/249; H04W 76/30; H04W 84/06

(57) ABSTRACT

A method implemented in a node of a non-terrestrial radio access network (RAN) comprises transmitting (502), to a core network (CN), information related to a switchover of the node from a first feeder link (FL), via which the node communicates with the CN, to a second FL; and forwarding (524), from the CN to a user equipment (UE), switchover event parameters related to the switchover.

### CROSS-REFERENCE TO RELATED APPLICATION

This application claims priority to and the benefit of the filing date of provisional U.S. Patent Application No. 63/554,827 entitled “Method and System for Handling UE Accessing Regenerative-Based Satellite for Feeder Link Switchover,” filed on Feb. 16, 2024 and provisional U.S. Patent Application No. 63/554,893 entitled “Method and System for Providing Feeder Link Switchover Event Information for a UE Accessing Regenerative-Based Satellite,” filed on Feb. 16, 2024. The entire content of the provisional applications is hereby expressly incorporated herein by reference.

### FIELD OF THE DISCLOSURE

This disclosure relates generally to wireless communications and, more particularly, to a user equipment (UE) accessing a non-terrestrial network (NTN) when a feeder link between a terrestrial station and a satellite changes.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Although the fifth generation (5G) communication technology relies primarily on terrestrial networks, the 3rd Generation Partnership Project (3GPP) organization has proposed to extend 5G communications to non-terrestrial networks (NTNs) with 5G new radio (NR) access techniques or with Long-Term-Evolution (LTE) access techniques. In an NTN, a radio frequency (RF) transceiver can reside on a satellite, an uncrewed aircraft system (UAS) also referred to as a drone, a balloon, an airplane, or another suitable apparatus. For simplicity, the discussion below refers to all such apparatus as satellites.

In addition to satellites, an NTN can include sat-gateways that connect the NTN to a public data network, feeder links between sat-gateways and satellites, service links to UEs, and inter-satellite links (ISL) when satellites form constellations. A satellite can belong to one of several types based on altitude, orbit, and beam footprint size. The types include a Low-Earth Orbit (LEO) satellite, a Medium-Earth Orbit (MEO) satellite, a Geostationary Earth Orbit (GEO) satellite, a UAS platform (including High Altitude Platform Station, HAPS), and a High Elliptical Orbit (HEO) satellite. GEO satellites are also known as Geosynchronous Orbit (GSO) satellites, and LEO/MEO satellites are also known as non-GSO (NGSO) satellites.

A GSO satellite can communicate with one or several sat-gateways deployed over a satellite targeted coverage area (e.g. a region or even a continent). A non-GSO satellite at different times can communicate with one serving sat-gateways via one feeder link or with several serving sat-gateways via respective feeder links. One of the objectives of NTN design is service and feeder link continuity between successive serving sat-gateways, with sufficient time duration to proceed with mobility anchoring and handover.

A satellite can support a transparent payload, to essentially operate as a radio repeater and extend the Uu interface for a terrestrial base station, or a regenerative payload that provides on-board processing to implement base station functionality, e.g., at least a portion of the functionality of a Next Generation Node B (gNB). A satellite typically generates several beams for a given service area bounded by the field of view of the satellite. The footprints of the beams typically have an elliptic shape and depend on the on-board antenna configuration and the elevation angle of the satellite. For a transparent payload implementation, a satellite can apply RF filtering and frequency conversion and amplification, and not change the waveform signal. For a regenerative payload implementation, a satellite can apply RF filtering, frequency conversion and amplification, demodulation and decoding, routing, and/or coding/modulation.

The regenerative-payload approach presents several challenges related to feeder link switchover. In particular, a user equipment (UE) can access, via a service link, a base station mounted on a satellite defining a node of a satellite-based radio access network (RAN-Sat), while remaining substantially stationary relative to the satellite. The satellite can move relative to the terrestrial network elements and, at some point, switch from a feeder link connecting the satellite to a first terrestrial station (or an “earth station” (ES) 1) to a feeder link connecting the satellite to a second terrestrial station, ES2. The switchover results in a change in Transport Network Layer (TNL) association between the RAN-Sat node and the core network (CN), particularly at the Access and Mobility Management Function (AMF) in a 5G core (5GC) or Mobility Management Entity (MME) in an evolved packet core (EPC) in case of the 4G implementation. The UE meanwhile can continue to communicate with the RAN-Sat node via the same service link.

When the ES1 and ES2 belong to different service areas, the serving AMF or MME can change after a feeder link switchover. The UE accordingly should perform a mobility registration update. However, because the feeder link switchover changes the TNL association between the RAN-Sat and the CN, it is unclear how the RAN-Sat can provide feeder link switchover event information to the UE before the feeder link switchover event begins to impact the UE. Further, it is not clear how the UE can determine that the UE should trigger a registration request procedure for a mobility registration after the feeder link switchover event ends.

### SUMMARY

An example embodiment of the techniques of this disclosure is a method implemented in a node of a non-terrestrial radio access network (RAN). The method comprises transmitting, to a core network (CN), information related to a switchover of the node from a first feeder link (FL), via which the node communicates with the CN, to a second FL; and forwarding, from the CN to a user equipment (UE), switchover event parameters related to the switchover.

Another example embodiment of these techniques is a method implemented in a node of a non-terrestrial RAN. The method comprises transmitting, to a UE, an indication of a start time of an FL switchover event including a switchover of the node from a first FL, via which the node communicates with a first CN, to a second FL for communicating with a second CN; and receiving, from the UE after the switchover completes, a registration request for the second CN.

Another example embodiment of these techniques is a node of a non-terrestrial RAN comprising a transceiver; and processing hardware. The node is configured to: transmit, to a CN, information related to a switchover of the node from a first FL, via which the node communicates with the CN, to a second FL. The node is further configured to forward, from the CN to a UE, switchover event parameters related to the switchover.

### BRIEF DESCRIPTION OF THE DRAWINGS

FIG. 1 is a block diagram of an example wireless communication system in which a user equipment (UE) and/or a base station efficiently manage feeder link (FL) switchover events;

FIG. 2 is a block diagram of an example protocol stack according to which the UE of FIG. 1A communicates with base stations;

FIGS. 3A and 3B illustrate known regenerative-based satellite access configurations;

FIG. 4 is a messaging diagram of an example scenario in which a RAN-Sat provides FL switchover event information to a UE directly or via the core network (CN), and the UE subsequently initiates a registration request after the FL switchover event completes;

FIG. 5 is a messaging diagram of an example scenario generally similar to that of FIG. 4, but in which the source AMF obtains FL switchover event information from the RAN-Sat or from a stored pre-configuration, and generates FL switchover event parameters based on the FL switchover event information;

FIG. 6 is a messaging diagram of an example scenario generally similar to that of FIG. 4, but in which the UE obtains FL switchover event information from the RAN-Sat and provides the FL switchover event information to source AMF, which then generates FL switchover event parameters based on the FL switchover event information; and

FIGS. 7A-C illustrate several example methods for providing FL switchover event information to the UE, which can be implemented in the RAN-Sat of FIG. 1.

### DETAILED DESCRIPTION OF THE DRAWINGS

As discussed in more detail below, a network provides FL switchover assistance information to a UE. When the UE detects an upcoming FL switchover event, the UE determines whether a registration update is necessary based on the FL switchover assistance information. In particular, when the UE determines that the FL switchover event involves a core network, the UE can determine that a registration update is necessary. In some cases, the UE further determines the timing of the registration update based on the FL switchover assistance information. In some implementations, the UE receives FL switchover assistance information in a broadcast message in a currently serving cell, and in other implementations the UE receives the FL switchover assistance information in a message addressed specifically to the UE.

The UE and/or the network can also implement overload control to prevent a large number of UEs from requesting registration updates at the same time. To this end, the UE and/or a base station can select timer values within a certain range, which the core network can specify, or which can be pre-configured for the FL switchover procedure.

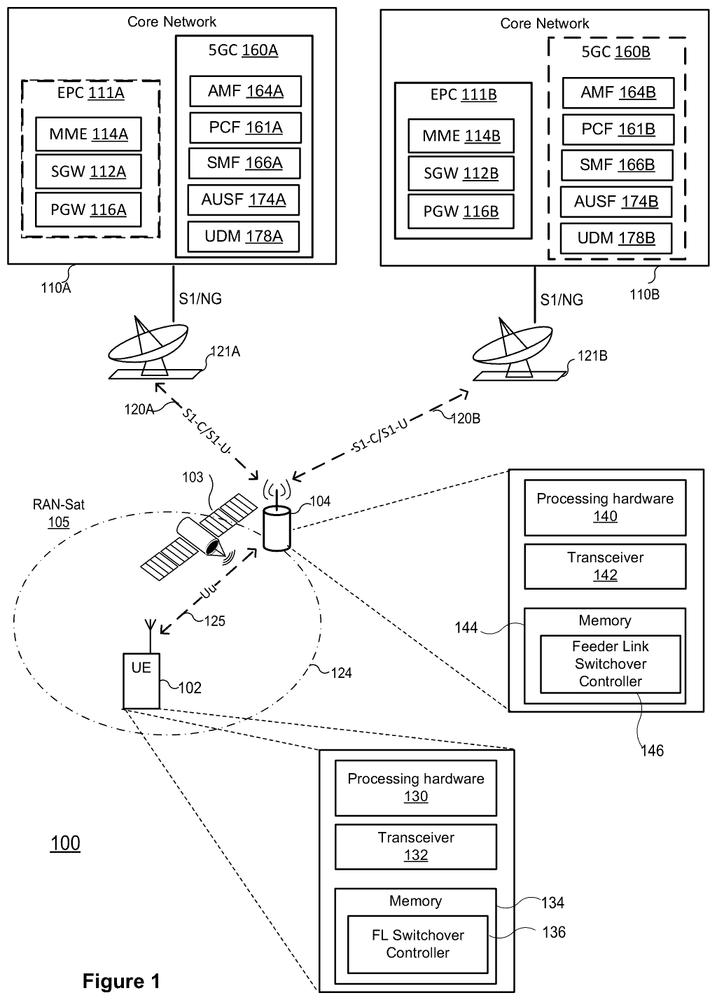

Referring first to FIG. 1, an example wireless communication system 100 includes a UE 102, a base station 104 operating on a satellite 103 according to the regenerative payload architecture, as a part of a satellite radio access network (RAN-Sat) 105, and core networks (CN) 110A and 110B. Although the RAN 105 in this and the subsequent examples is a RAN-Sat, in general the techniques of this disclosure can apply to any suitable NTN RAN or a non-terrestrial node of a RAN. In general, the RAN-Sat 105 can include any number of base stations, and each of the base stations can cover one, two, three, or any other suitable number of cells. The base station 104 connects to the CN 110A via a feeder link 120A and a terrestrial network element 121A, and to the CN 110B via a feeder link 120B and a terrestrial network element 121B. The feeder links feeder link 120A and 120B can support the S1-C and SC-U interfaces. The base station 103 can be an Evolved Node B (eNB) or a Next Generation Node B (gNB), for example.

The CN 110A can be implemented as an evolved packet core (EPC) 111A or a fifth generation (5G) core (5GC) 160A, for example. The CN 110A can also be implemented as a sixth generation (6G) core in another example.

The EPC 111A can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network.

The 5GC 160A can include an Access and Mobility Management Function (AMF) 164A, a Policy Control Function (PCF) 161A, a Session Management Function (SMF) 166A, an

Authentication Server Function (AUSF) 174A, and a Unified Data Management Function (UDM) 178A. The AMF 164A is generally configured to manage registration, connection, and mobility of a UE (such as the UE 102) and provide transport for session management (SM) messages between the UE 102 and the SMF 366. The SMF 366 is generally configured to manage packet data unit (PDU) sessions, allocate Internet Protocol (IP) addresses for UEs, and provide downlink (DL) notifications. The PCF 161A manages policies such as quality of service (QoS) and authentication policies, for example. The UDM 178A is generally configured to handle user identification, access authorization based on subscription data, and subscription management.

The CN 110B can include components 111B-116B similar to the components 111A-116A, and 161B-178B similar to the components 161A-178A. In some configurations of the system 100, the CNs 110A and 110B implement different generations of technology, e.g., the CN 110A implements the 5GC 160A functionality, and the CN 110B implements the EPC 111B functionality. In other configurations, the CN 110A and the CN 110B implement the same generation of technology.

The UE 102 is equipped with processing hardware 130 that can include one or more general-purpose processors such as CPUs and non-transitory computer-readable memory storing machine-readable instructions executable on the one or more general-purpose processors, and/or special-purpose processing units. The UE 102 further includes a transceiver 132 configured to transmit data in the uplink direction and receive data transmitted in the downlink direction. A memory 134 can include an FL switchover controller 136 configured to efficiently detect and manage FL switchover events and manage the related overload, as discussed in further detail below.

The base station 104 similarly is equipped with processing hardware 140 that can include one or more general-purpose processors such as CPUs and non-transitory computer-readable memory storing machine-readable instructions executable on the one or more general-purpose processors, and/or special-purpose processing units. The base station 104 further includes a transceiver 142 configured to transmit data in the downlink direction and receive data transmitted in the uplink direction. A memory 144 can include an FL switchover controller 146 configured to generate FL switchover assistance information, manage overload related to FL switchover assistance information, etc.

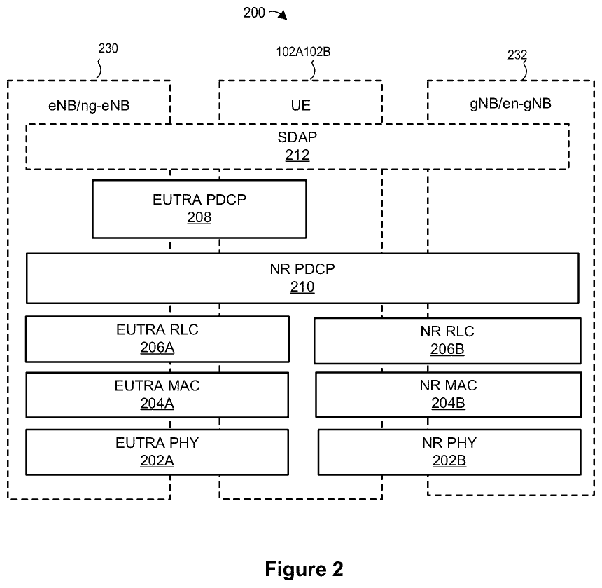

FIG. 2 illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

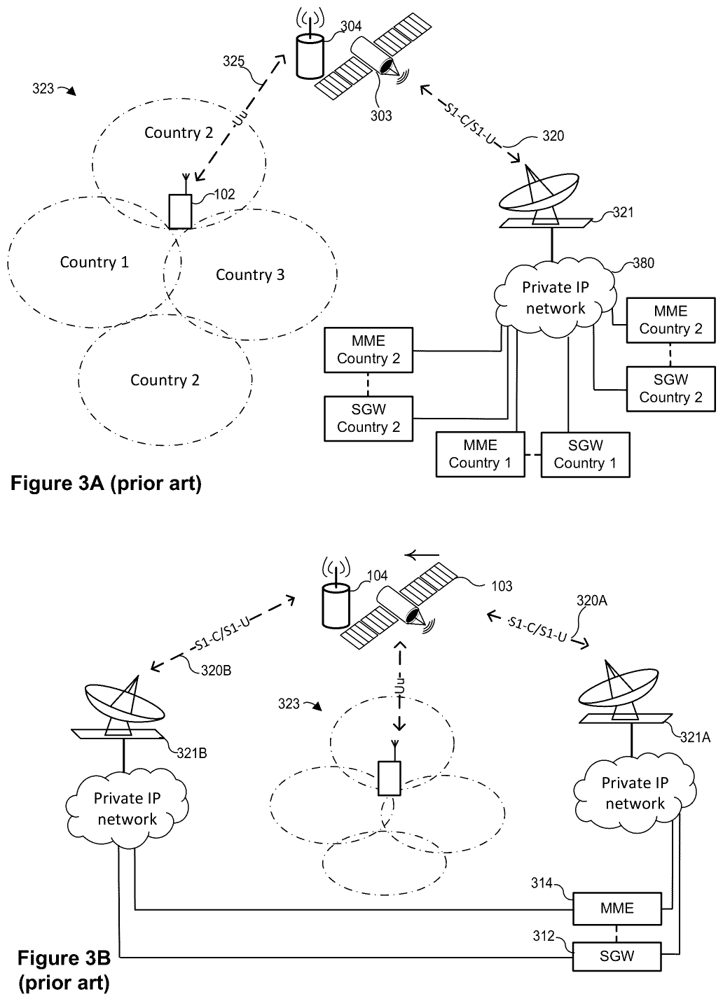

For clarity, FIGS. 3A and 3B illustrates known scenarios associated with regenerative-based satellite access. Referring first to FIG. 3A, a base station 304, which can be implemented as an eNB-Y, operates on a LEO satellite 303. Earth stationary cells 323 cover countries 1, 2, 3 in this scenario, and the UE 102 in this scenario is in a cell of country 2 and accesses the base station 304 via a Uu service link 325. The base station 304 connects, via a feeder link 320, to an earth station(ES) 321, which in turn connects, via a private IP network 380, to three MME pools corresponding to countries 1, 2, and 3, respectively.

FIG. 3B illustrates a switchover from a feeder link 320A to a feeder link 320B. The LEO satellite 303 moves in the direction of the arrow in FIG. 3B. The UE 102 is substantially stationary in a certain earth stationary cell, while the base station 304 mounted on the LEO satellite 303 moves out of the range of an ES 321A and moves into the range of an ES 321B. According to this configuration, the ES 321A and the ES 321B access the same MME 314 and SGW 312.

However, the switchover from the feeder link 320A to the feeder link 320B in some scenarios also necessitates a change in core networks. The UE 102 in this case should transmit a registration request for a mobility registration update procedure.

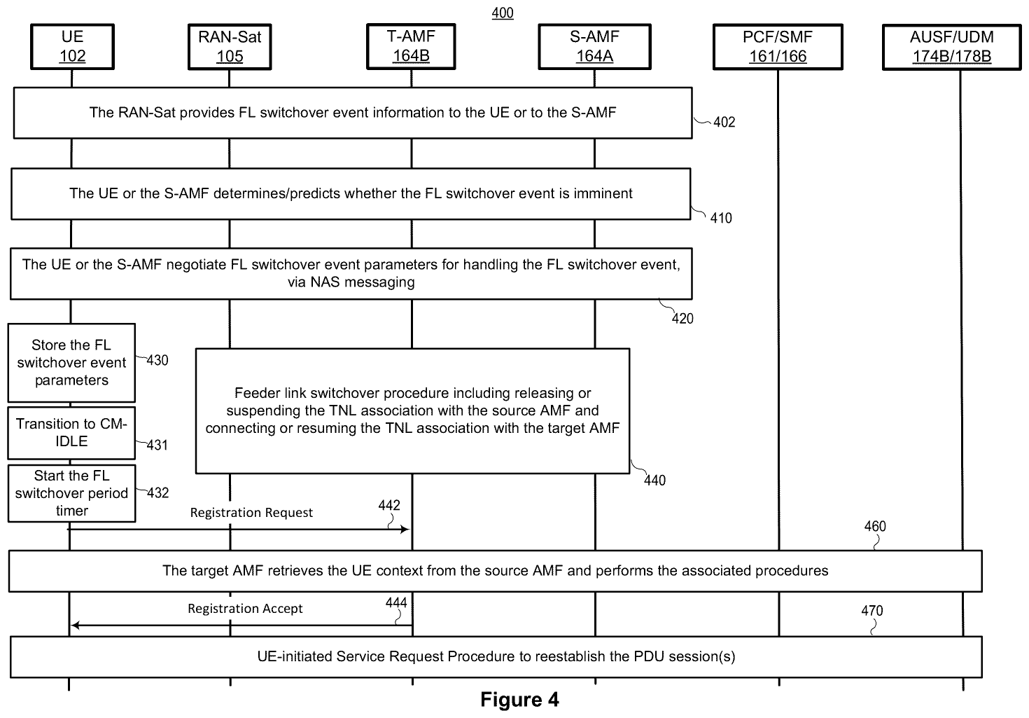

Next, FIGS. 4-6 illustrate several scenarios in which a RAT provides FL switchover event information to a UE. Generally speaking, similar events in these drawings are labeled with similar reference numbers that share two least significant digits, with differences discussed below where appropriate. For example, event 430 is similar to event 530, and event 440 is similar to event 540.

Referring first to a scenario 400 illustrated in FIG. 4, a node of the RAN-Sat 105, such as the base station 104, performs an FL switchover that requires a change from the source (or “old”) AMF 164A to the target (or “new”) AMF 164B. For convenience, the discussion below refers to a node of the RAN-Sat 105 simply as “the RAN-Sat 105.”

The RAN-Sat 105 provides 402, to the UE 102 or the S-AMF 164A, FL switchover event information. The UE 102 or the S-AMF 164A determines or predicts 410 whether the FL switchover event is imminent (i.e., will happen in the near future). The UE 102 and the S-AMF 164A negotiate 420 FL switchover event parameters, e.g., the duration of an FL switchover period and/or the start time of the FL switchover event. The UE 102 and the S-AMF 164A can negotiate 420 the FL switchover event parameters using NAS messages for example. The UE 102 and the S-AMF 164A perform 420 the negotiation to manage the Connection Management (CM) state of the UE and maintain the registration of the UE during the FL switchover event.

The UE 102 stores 430 the FL switchover event parameters. The 102 can transition 431 to the CM-idle state, in which the UE 102 has no active connection to a core network, based on the local configuration or in response to the RAN-Sat 105 disconnecting the RRC, for example. The UE 102 starts 432 an FL switchover timer with an expiration period based on (e.g., equal to) the duration of the FL switchover period, so that the FL switchover timer runs during the FL switchover event.

The S-AMF 164A, the T-AMF 164B, and the RAN-Sat 105 perform 440 an FL switchover procedure or event. During this procedure, the RAN-Sat 105 and the S-AMF 164A release or suspend the N2 connection with the first TNL association, and the RAN-Sat 105 can connect or resume the N2 connection with the second TNL association, with the S-AMF 164A (i.e., the same AMF) or the T-AMF 164B (i.e., a different AMF).

When the UE 102 determines that the FL switchover timer has expired (which means that the FL switchover event 440 should have completed), the UE 102 sends 442 a registration request message to the T-AMF 164B. The UE 102 can send 442 the registration request message based on an implicit indication in the FL switchover parameters. In another implementation or scenario, the FL switchover parameters include an explicit indication that the UE 102 is to perform a registration request procedure after the FL switchover event completes (e.g., a registration indication).

The T-AMF 164B retrieves 460 a UE context from the S-AFM 164A by sending an Namf_Communication_UEContextTransfer message and receiving an Namf_Communication_UEContextTransfer response message in response. The procedure 460 can include additional messaging related to retrieving a UE identify, authentication, AUSF selection, UDM selection, etc. specified in TS 23.502 V18.4.0 (2023-12) FIG. 4.2.2.2.2-1, steps 4-19. The T-AMF 164B sends 444, to the UE 102, a Registration Accept message. Finally, the UE 102 initiates 470 a service request procedure (e.g., in accordance with TS 23.501) to re-establish one or more PDU session(s) if the UE 102 transitions from the CM-idle to the CM-connected state. Alternatively, if the UE 102 performed 442 an initial registration, the UE 102 initiates 470 a PDU Session establishment request procedure to request a new service.

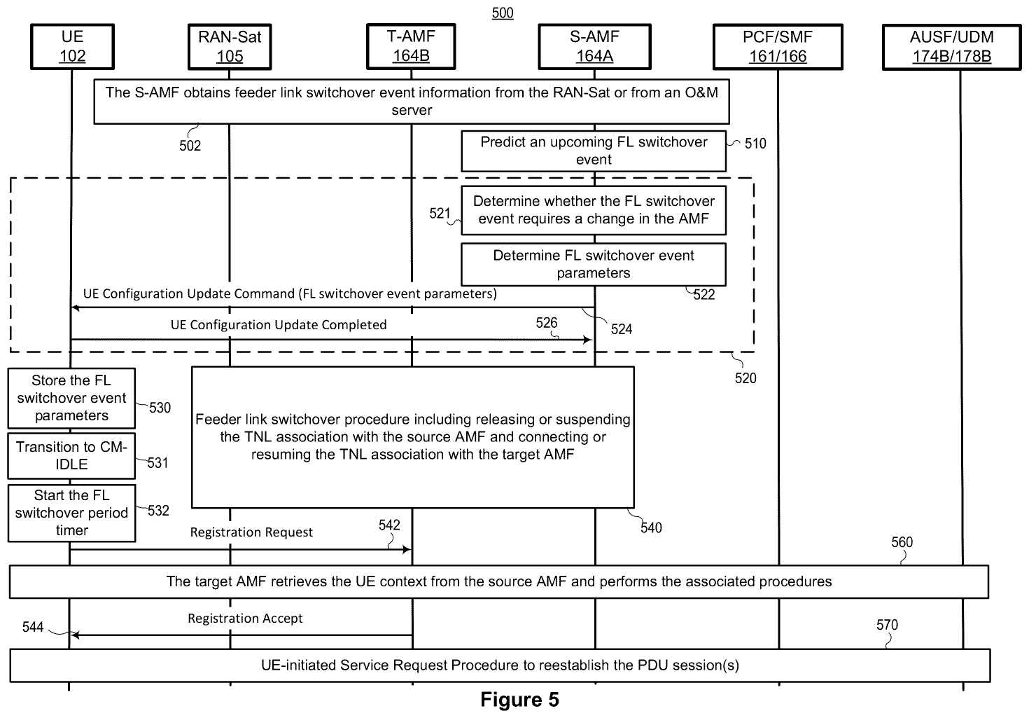

Now referring to FIG. 5, a scenario 500 is generally similar to the scenario 400, with the differences considered below. Here, the RAN-Sat 105 can provide FL switchover event information to the S-AMF 164A, which then configures the UE 102 to initiate a registration request after the FL switchover event completes, if the FL switchover event requires a change in the AMF.

In particular, the S-AMF 164A obtains 502 the FL switchover event information from the RAN-Sat 105 via an N2 message or from an O&M repository (not shown) based on the local pre-configuration. The S-AMF 164A predicts 510 an upcoming FL switchover event. The S-AMF 164A determines 521, based for example on the target service area and associated Tracking Area Identity (TAI) list, whether the FL switchover event will require a change of the core networks, particularly a change from the S-AMF 164A to the T-SMF 164B. The S-AMF 164A determines 522 FL event parameters based on the FL switchover event information obtained 502 earlier from the RAN-Sat 105 or the O&M server. The S-AMF 164A then sends 524, to the UE 102 via the RAN-Sat 105, a UE Configuration Update Command including FL switchover event parameters. The UE 102 then sends 526, to the S-AMF 164A and in response to the UE Configuration Update Command, a UE Configuration Update Completed message. The events 521, 522, 524, and 526 collectively can be understood as an FL switchover event parameter negotiation procedure 520.

Events 530, 531, 532, 540, 542, 544, 560, and 570 are similar to the events 430, 431, 432, 440, 442, 444, 460, and 470 discussed above.

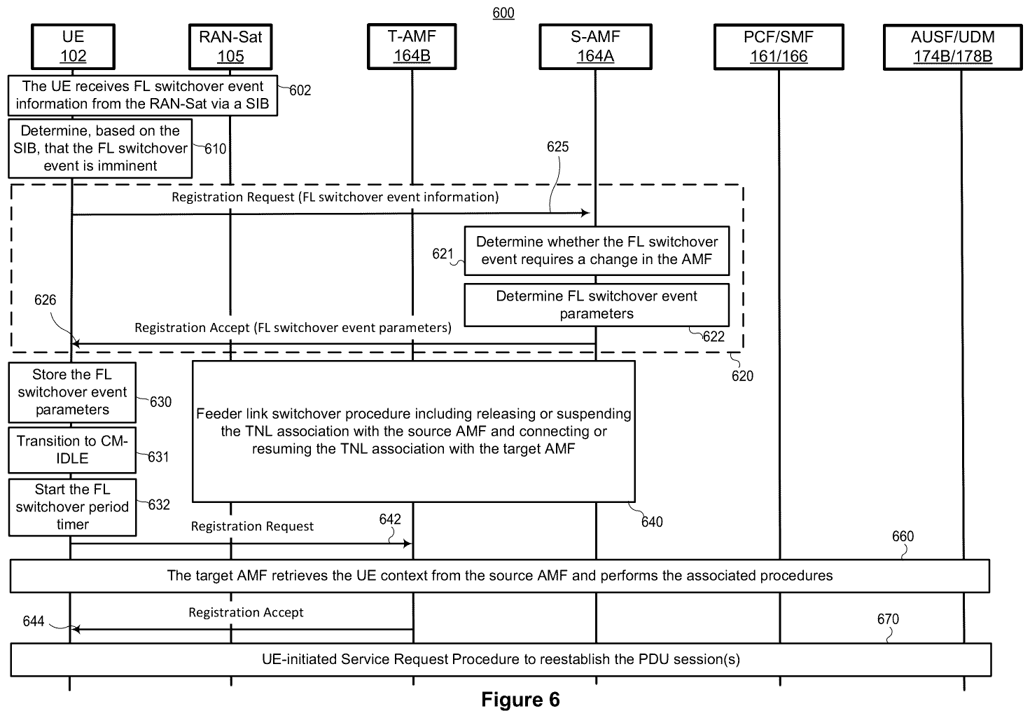

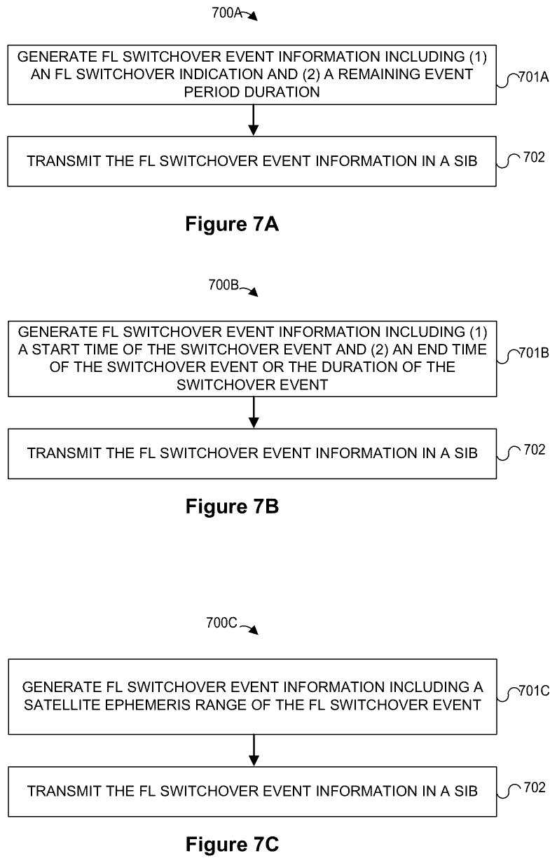

Next, FIG. 6 illustrates a scenario 600 that is generally similar to the scenario 400, but in this scenario the RAN-Sat 105 provides, to the UE 102 and via a broadcast message such as a system information block (SIB), FL switchover event information. Example techniques using 602 a SIB for conveying the FL switchover event information are discussed in more detail with reference to FIG. 7. After the UE determines 610, based on the SIB, that the FL switchover event is imminent, the UE 102 and the S-AMF 164A negotiate 620 FL switchover event parameters. During this negotiation, the S-AMF 164A configures the UE 102 to initiate a registration request after the FL switchover event completes, if the FL switchover event requires a change in the AMF.

More specifically, the UE 102 receives 602, in a SIB or other suitable broadcast message from the RAN-Sat 105, FL switchover event information. Using this information, the UE 102 then detects 610 an upcoming FL switchover event (i.e., determines that the FL switchover event is imminent). The UE 102 sends 625, to the S-AMF 164A, a Registration Request message including the FL switchover event information. The events 621 and 622 are similar to the events 521 and 522 discussed above. The S-AMF 164A sends 626, to the UE 102 and responsive to the Registration Request message, a Registration Accept message including FL switchover event parameters.

Events 630, 631, 632, 640, 642, 644, 660, and 670 are similar to the events 430/530, 431/531, 432/532, 440/540, 442/542, 444/544, 460/560, and 470/570 discussed above.

FIGS. 7A-C illustrate several example methods a RAN-Sat, such as the RAN-Sat 105 for example, can implement to generate and transmit FL switchover information. At block 701A of a method 700A illustrated in FIG. 7A, the RAN-Sat generates FL switchover event information that includes an FL switchover event indication, to indicate for example that the FL switchover event is ongoing, as well as the remaining duration of the switchover event, in the currently serving cell and/or one or more neighboring cells. More generally, the FL switchover event indication can indicate the status of the FL switchover event, and the value “active” for example can indicate that the FL switchover event is ongoing (e.g., has started or will start imminently and can be considered to be ongoing).

Alternatively, at block 701B of a method 700B illustrated in FIG. 7B, the RAN-Sat generates FL switchover event information that indicates the start time of the FL switchover event and the duration of the FL switchover event. If the FL switchover event is already ongoing, the RAN-Sat can set the start time to zero.

As another alternative, at block 701C of a method 700C illustrated in FIG. 7C, the RAN-Sat generates FL switchover event information that indicates the location of the FL switchover event, and particularly the satellite ephemeris range for the FL switchover event. The RAN-Sat can generate this information based on the satellite ephemeris information available to the RAN-Sat, for example. When the FL switchover event is already ongoing, the satellite ephemeris range can remain the same or can change based on the current ephemeris information.

It is also possible for the RAN-Sat to include the information from more than one of the blocks 701A-C. For example, the RAN-Sat can include both the timing information (e.g., the start time of the FL switchover event) and the location (e.g., the satellite ephemeris information) in the FL switchover event information.

At block 702 of the method 700A, 700B, or 700C, the RAN-Sat transmits the FL switchover even information via a broadcast message, for example (see, e.g., event 402 or 602). The broadcast message can be a certain SIB. The UE 102 can use the FL switchover even information to determine whether the FL switchover event is ongoing or upcoming at a time and/or location (e.g., the serving cell and/or a neighboring cell) the UE can determine.

In some implementations, at block 702 the RAN-Sat transmits is a SIB of a type dedicated specifically to conveying FL switchover event information (e.g., the timing and/or the location) or an existing SIB such as SIB19 for example. In some implementations, changes to the FL switchover event information do not result in system information change notifications or in changes of the valueTag in SIB1.

One example definition of the special-purpose SIB dedicated to conveying FL switchover event information is as follows:

| SIB ::= SEQUENCE { | | |
|---|---|---|
| FL-switchover-info | FL-switchover-info | OPTIONAL, |
| | | -- NEED R |
| lateNonCriticalExtension | OCTET STRING | OPTIONAL, |

...
}

In another implementation, a SIB19 includes the FL switchover event information in an ntn-Config information element (IE):

SIB19 ::= SEQUENCE {

| | | |
|---|---|---|
| FL-switchover-info | FL-switchover-info | OPTIONAL, -- NEED R |
| ntn-Config-r17 | NTN-Config-r17 | OPTIONAL, -- NEED R |
| ntn-NeighCellConfigList-r17 | ntn-NeighCellConfigList-r17 | OPTIONAL, -- NEED R |

...
}

In another implementation, a SIB19 includes the FL switchover as a part of NTN-Config at a serving cell and/or NTN-NeighCellConfigList at the neighboring cells:

SIB 19 ::= SEQUENCE {

| | | |
|---|---|---|
| ntn-Config-(new) | NTN-Config-(new) | OPTIONAL, -- NEED R |
| ntn-Config-r17 | NTN-Config-r17 | OPTIONAL, -- NEED R |
| ntn-NeighCellConfigList-(new) | NTN-NeighCellConfigList-(new) | OPTIONAL, -- NEED R |

```
  ...
  }
NTN-NeighCellConfigList-(new) ::= SEQUENCE (SIZE(1..maxCellNTN-r17)) OF NTN-
NeighCellConfig-(new)
```

| | | |
|---|---|---|
| NTN-NeighCellConfig-(new) ::= | SEQUENCE { | |
| ntn-Config-(new) | NTN-Config-(new) | OPTIONAL, -- NEED R |
| carrierFreq-r17 | ARFCN-ValueNR | OPTIONAL, -- NEED R |
| physCellId-r17 | PhysCellId | OPTIONAL, -- NEED R |

}

| NTN-Config-(new) ::= | SEQUENCE { | |
|---|---|---|
| (new) fl-switchover-info | FL-switchover-info | OPTIONAL, -- NEED R |
| epochTime-r17 | EpochTime-r17 | OPTIONAL, -- NEED R |
| ntn-UlSyncValidityDuration-r17 | ENUMERATED{ s5, s10, s15, | OPTIONAL, -- NEED R |
| | s20, s25, s30, s35, s40, s45, s50, | |
| | s55, s60, s120, s180, s240, s900} | |
| cellSpecificKoffset-r17 | INTEGER(1..1023) | OPTIONAL, -- NEED R |
| kmac-r17 | INTEGER(1..512) | OPTIONAL, -- NEED R |
| ta-Info-r17 | TA-Info-r17 | OPTIONAL, -- NEED R |
| ntn-PolarizationDL-r17 | ENUMERATED {rhcp,1hcp,linear} | OPTIONAL, -- NEED R |
| ntn-PolarizationUL-r17 | ENUMERATED {rhcp,1hcp,linear} | OPTIONAL, -- NEED R |
| ephemerisInfo-r17 | EphemerisInfo-r17 | OPTIONAL, -- NEED R |
| ta-Report-r17 | ENUMERATED {enabled} | OPTIONAL, -- NEED R |

...
}

In other implementations, at block 702 the RAN-Sat transmits a SIB including an NTN-Config 1E with an in EphemerisInfo IE, which in turn includes FL switchover event information. According to this approach, the FL switchover event information indicates, to the UEs in the cell, that FL switchover event is ongoing, or will start at a specific time and/or a specific location (as indicated in the satellite ephemeris information), at the relevant satellite.

In one example implementation, the FL switchover event information includes an FL switchover indication, to explicitly indicate that the satellite is going though an FL switchover.

In another example implementation, the FL switchover event information includes an FL switchover indication as well as the duration of the remaining FL switchover event. As indicated above, this information indicates, to a UE, that the FL switchover event is ongoing and will continue for the indicated remainder of the FL switchover event.

In yet another example implementation, the FL switchover event information includes an indication of the start time of the FL switchover event and an indication of either the end time of the FL switchover event or of the duration of the FL switchover event. In this case, the FL switchover information indicates that the satellite will start the FL switchover event at the start time, and that the FL switchover event will last until the indicated end time or through the indicated duration.

In yet another example implementation, the FL switchover event information indicates the location of the FL switchover event, based on the satellite ephemeris info. In particular, the FL switchover event information in this case can include a satellite ephemeris range of the FL switchover event. For the ongoing FL switchover event, the satellite ephemeris can remains the same or can change based on the current ephemeris information.

In the examples above, the start time, the end time, and the duration of the FL switchover period are estimates or predictions the RAN-Sat generates based on the available information.

An example definition of the ephemeris information the RAN-Sat 105 can broadcast at block 702 is provided below:

| EphemerisInfo-(new) ::= | Choice { | |
|---|---|---|
| (new) fl-swithover-info | FL-switchover-info | OPTIONAL, |
| | | -- NEED R |

| | |
|---|---|
| positionVelocity-r17 | PositionVelocity-r17, |
| orbital-r17 | Orbital-r17 |
| ... | |
| } | |

The following description may be applied to the description above.

Generally speaking, description for one of the above figures can apply to another of the above figures. Any event or block described above can be optional. For example, an event or block with dashed lines can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. The “eNB” can be replaced by “base station”, “gNB”, “6G base station”, “evolved gNB” or 6G gNB.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method implemented in a node of a non-terrestrial radio access network (RAN), the method comprising:
transmitting, to a core network (CN), information related to a switchover of the node from a first feeder link (FL), via which the node communicates with the CN, to a second FL; and
forwarding, from the CN to a user equipment (UE), switchover event parameters related to the switchover.

2. The method of claim 1, wherein the information related to the switchover includes a duration of a switchover event including the switchover.

3. The method of claim 1, wherein the information related to the switchover includes a start time of the switchover.

4. The method of claim 1, wherein the information related to the switchover includes an end time of the switchover.

5. The method of claim 1, wherein the information related to the switchover includes an indication that the switchover is ongoing at a cell served by the node.

6. The method of claim 1, wherein:
the CN is a first CN; and
after the switchover, the node communicates with the second CN via the second FL.

7. The method of claim 6, further comprising:
suspending or releasing, during the switchover, a first N2 connection with a first Transport Network Layer (TNL) association between the node and the first CN; and
connecting, after the switchover, to the second C2, via a second N2 connection with a second TNL association between the node and the second CN.

8. A method implemented in a node of a non-terrestrial radio access network (RAN), the method comprising:
transmitting, to a user equipment (UE), an indication of a start time of a feeder link (FL) switchover event including a switchover of the node from a first FL, via which the node communicates with a first CN, to a second FL for communicating with a second CN; and
receiving, from the UE and after the switchover event completes, a registration request for the second CN.

9. The method of claim 8, further comprising:
transmitting an indication of a duration of the FL switchover event.

10. The method of claim 8, further comprising:
transmitting an indication of an end time of the FL switchover event.

11. The method of claim 8, wherein the transmitting of the indication includes transmitting a system information block (SIB).

12. The method of claim 11, wherein the SIB is a special-purpose dedicated to conveying FL switchover event parameters.

13. The method of claim 11, wherein the SIB includes a special-purpose information element (IE) dedicated to conveying FL switchover event parameters.

14. A node of a non-terrestrial radio access network (RAN) comprising:
a transceiver; and
processing hardware; the node configured to:
transmit, to a core network (CN), information related to a switchover of the node from a first feeder link (FL), via which the node communicates with the CN, to a second FL, and
forward, from the CN to a user equipment (UE), switchover event parameters related to the switchover.

15. The node of claim 14, wherein the information related to the switchover includes a duration of a switchover event including the switchover.

16. The node of claim 14, wherein the information related to the switchover includes a start time of the switchover.

17. The node of claim 14, wherein the information related to the switchover includes an end time of the switchover.

18. The node of claim 14, wherein the information related to the switchover includes an indication that the switchover is ongoing at a cell served by the node.

19. The node of claim 14, wherein:
the CN is a first CN; and
after the switchover, the node communicates with the second CN via the second FL.

20. The node of claim 19, further configured to:
suspend or release, during the switchover, a first N2 connection with a first Transport Network Layer (TNL) association between the node and the first CN; and
connect, after the switchover, to the second C2, via a second N2 connection with a second TNL association between the node and the second CN.
